(19) United States
(12) Patent Application Publication
(10) Pub. No.: US 2013/0340551 A1
(43) Pub. Date: Dec. 26, 2013

(54) Reversing Hub

(71) Applicant: Laury Grandi, Concórdia (BR)

(72) Inventor: Laury Grandi, Concórdia (BR)

(21) Appl. No.: 13/997,775

(22) PCT Filed: Nov. 25, 2011
(86) PCT No.: PCT/BR2011/000446

§ 371 Date: Sep. 11, 2013

(30) Foreign Application Priority Data
Jan. 14, 2011 (BR) MU9100113-7

(51) Int. Cl. F16H 3/00

(52) U.S. Cl. CPC F16H 3/00
USPC 74/404

(57) ABSTRACT

REVERSING HUB designed and built with the purpose of providing an improvement on reversing systems performing separately from the sequential gearbox of land and aquatic motor vehicles installed separately from the original gearbox of such motor vehicles without changing the composition and functioning of the gearbox, so as to provide that the user has not only a reverse gear, but also uses all sequential forward gears in these motor vehicles as sequential reverse gears.

### FIELD OF THE INVENTION

The present invention is in the field of hubs for use on gearboxes of land and aquatic motor vehicles.

### BACKGROUND OF THE INVENTION

The reversing box systems that perform separately from the gearbox in land or aquatic motor vehicles have application whenever there is the need of inverting the rotation direction of the driving force that drives such motor vehicles.

In the case of motor vehicles characterized as tricycles, mopeds and motorcycles, reversal boxes are broadly used to obtain reverse gear, for such vehicles are provided with a sequential engine, which makes the reversion system within the gearbox unfeasible, whether due to construction and to its costs.

Reversal boxes currently used, that allow reverse gear in tricycles, mopeds and motorcycles, have various problems, which this utility model comes, in its state-of-the-technique, to solve.

As a problem existing in the reversal boxes currently used, we have the existence of a large number of gears involved to transmit the motion to the wheels of such vehicles, even when moving forward, since at least three gears shall be constantly engaged, causing marked noise. Another problem in the reversal boxes currently used is that, due to the large amount of gears involved in the transmission, we have a marked loss of power transferred to the wheels responsible for the traction of the vehicle, for it is known that the greater the number of gears transmitting force and/or motion, the greater shall be the losses. Another problem in the reversal boxes currently used in motor vehicles, mainly in mopeds, is the need of adoption of a frame on the rear wheels, for the reversal box to be coupled to, since its hull must remain immoveable and fixed, as a gearbox. Another problem in the reversal boxes currently used in motor vehicles, mainly in cargo tricycles, is their layout in the vehicle, which is normally positioned between the engine/transmission and the transmission system at the rear of the vehicle, generating a large amount of components for transmission of the force/motion to the rear wheels, causing excessive loss in the power transmitted to the wheels, in addition to a higher maintenance cost, since, as there is a greater number of components involved in the vehicle's transmission, the greater shall be the quantity of parts undergoing wear and tear. Another problem in the reversal boxes currently used in motor vehicles is that their constructive layout makes this reversal system unfeasible for being used in motorcycles, mainly due to engineering factors, such as their positioning in the gearbox, greater loss of power for the rear wheel, excessive noise, more expensive maintenance due to the greater amount of components, which is the reason why almost all makers of motorcycles choose to use electric engines designed to generate traction reversal in large motorcycles, which generates high costs for the installation of such component by the consumer and becomes an optional item when it should be a series item, in addition to the large demand of the motorcycle battery and the early wear and tear of such components, generating a higher maintenance cost.

Problems existing in the reversal boxes currently used in motor vehicles may be thus summarized due to the technical and economic issues informed herein. Technical problems existing in the reversal boxes currently used in motor vehicles consist in the large amount of gearings that generates excessive noise even when the reversal is not active, as well as it generates difficulty in the maintenance and repair resulting from the large number of existing components. Another technical problem existing in the reversal boxes currently used in motor vehicles consists in the need of using a hull that must remain fixed such as in a gearbox, generating difficulty in the installation of a reversal box in motor vehicles such as mopeds, tricycles and motorcycles, for the reversal box must be coupled to a frame system, wherein the traction system of motor vehicles such as mopeds resides, or the reversal box may be positioned between the transmission and the system of traction axles of the wheels of motor vehicles such as tricycles, or the reversal box may be installed at the output of the gearbox of motor vehicles such as motorcycles and tricycles. Economic problems existing in the reversal boxes currently used in motor vehicles consist in the large amount of components used that generate excessive wear and tear due to being constantly engaged, even when the reversal is not activated, generating greater maintenance costs.

Aiming at solving the problems described above, it has been long needed a reversing apparatus designed and built with the purpose of providing an improvement in the reversal system mainly in vehicles provided with sequential transmission, such as tricycles, mopeds and motorcycles.

### SUMMARY OF THE INVENTION

The present invention seeks to provide a reversing apparatus for reversing a vehicle, the vehicle having an engine, a driveline means coupled to the engine, and a driving means; the reversing apparatus comprising: (a) a crown constructed and arranged to receive the driveline means; (b) an axis coupled to the crown; (c) a hub coupled to the driving means, the hub comprising a direct drive gear and a reverse drive gear, and (d) an actuator coupling the axis to either the direct drive gear or to the reverse drive gear; wherein when the axis is coupled to the direct drive gear the hub rotates in the same direction as the axis and wherein when the axis is coupled to the reverse drive gear the hub rotates in the opposite direction as the axis.

### BRIEF DESCRIPTION OF THE DRAWINGS

FIG. 1 is a perspective view of the reversing apparatus disassembled and with all parts discriminated and next to each other in order of assembly.

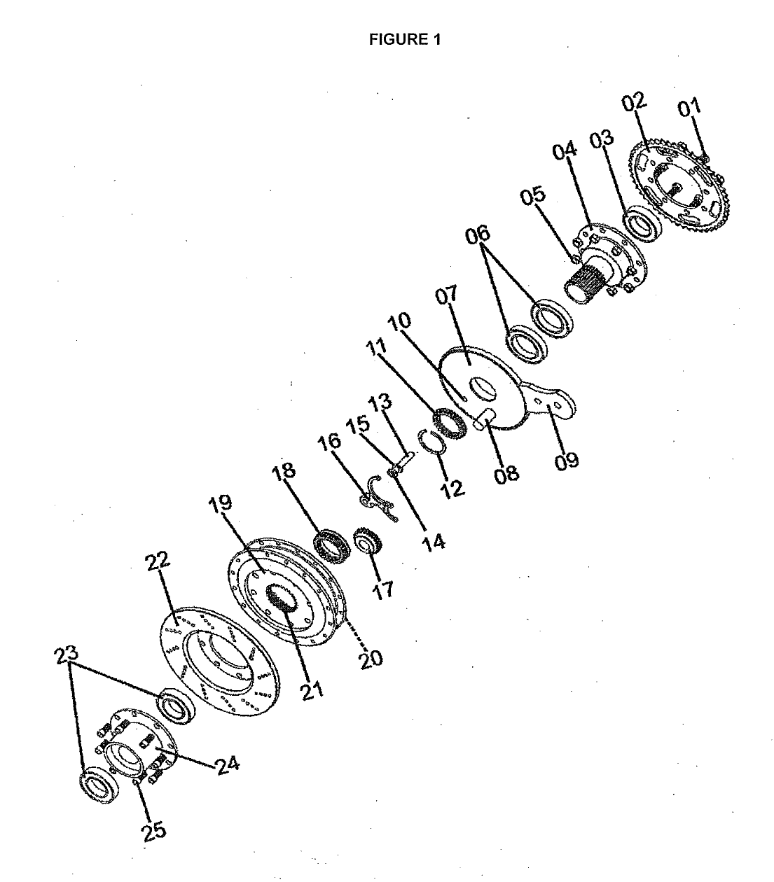

FIG. 2 is a perspective view of the reversing apparatus as shown in FIG. 1, from a different angle enabling the view of a reversing hub inner-teethed gearing (20), rendering the discrimination of parts comprising the a reversing apparatus complete.

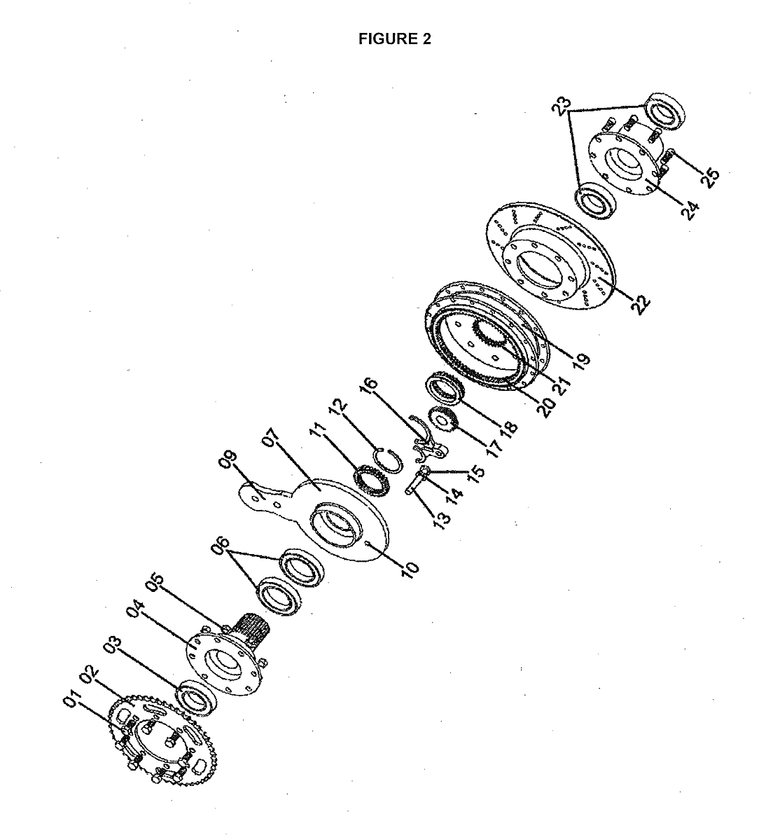

FIG. 3 is a perspective view of the reversing apparatus with the reversing system enabled, being partially assembled and with some parts cut, for a better view of the layout of the gearings.

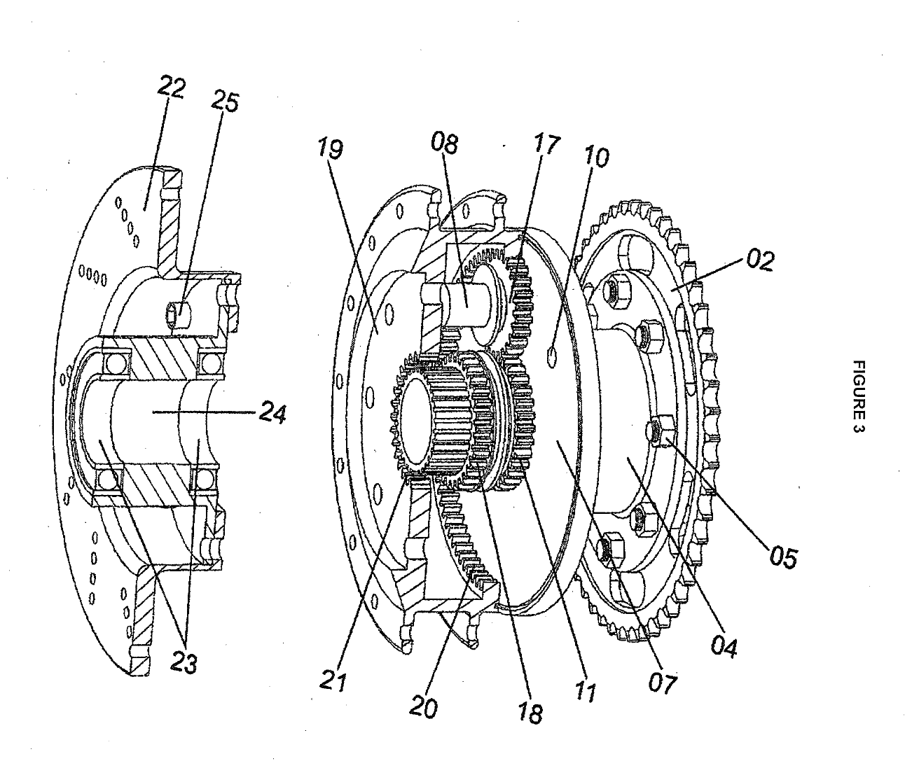

FIG. 4 is a supplementary perspective view of the reversing apparatus if FIG. 3.

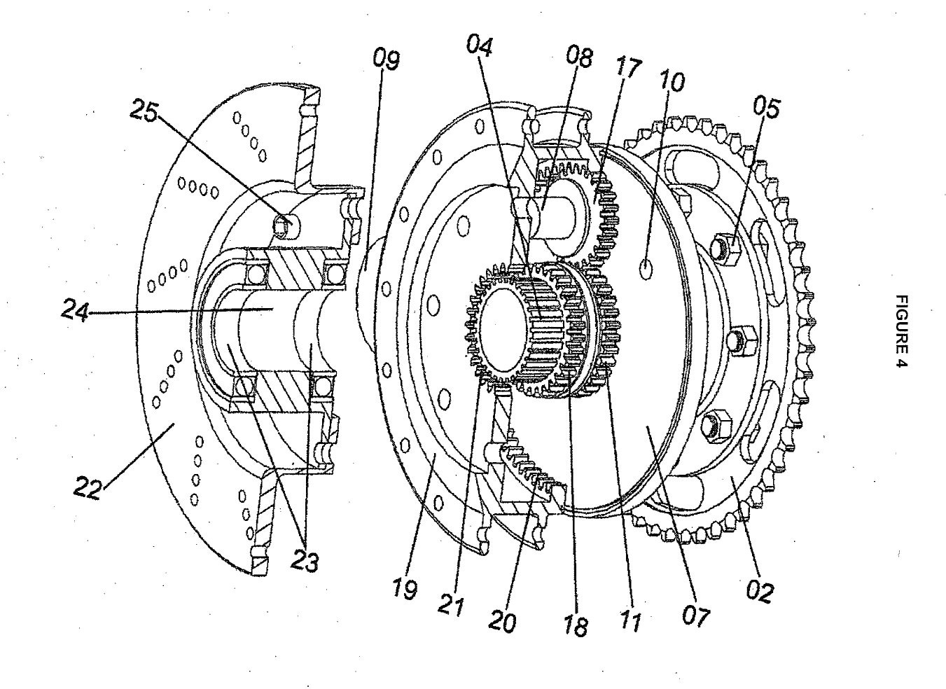

FIG. 5 is a perspective view of the reversing apparatus of FIG. 3 and FIG. 4 with the reversing system enabled, but completely assembled and maintaining the same parts cut enabling the view of the gearings.

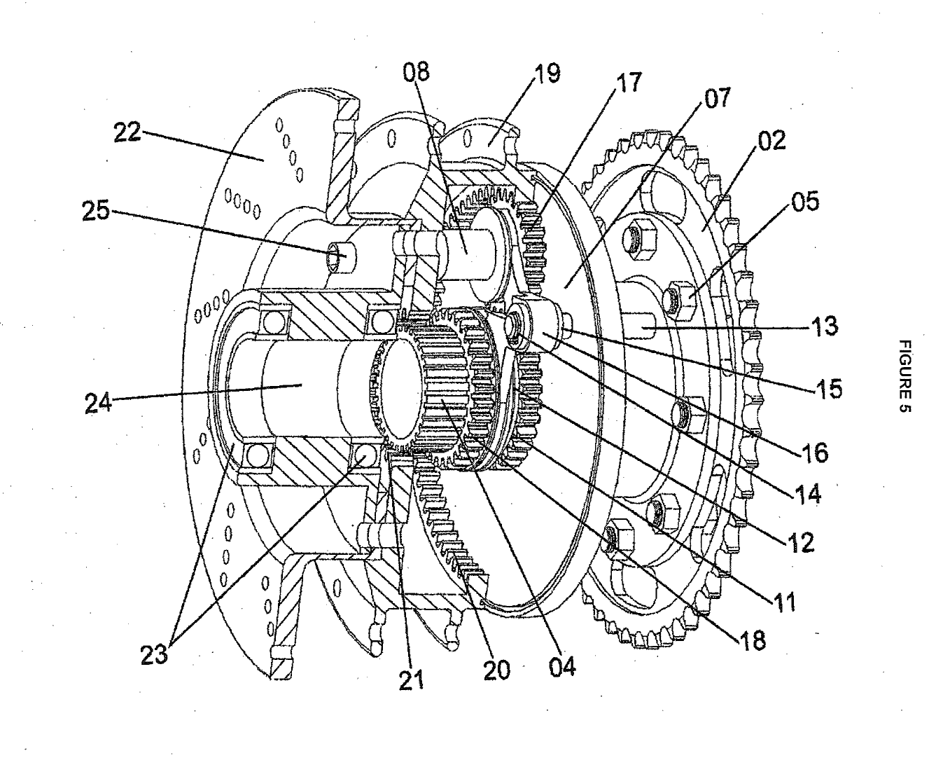

FIG. 6 is a perspective view of the reversing apparatus with the reversing system enabled in a supplementary angle.

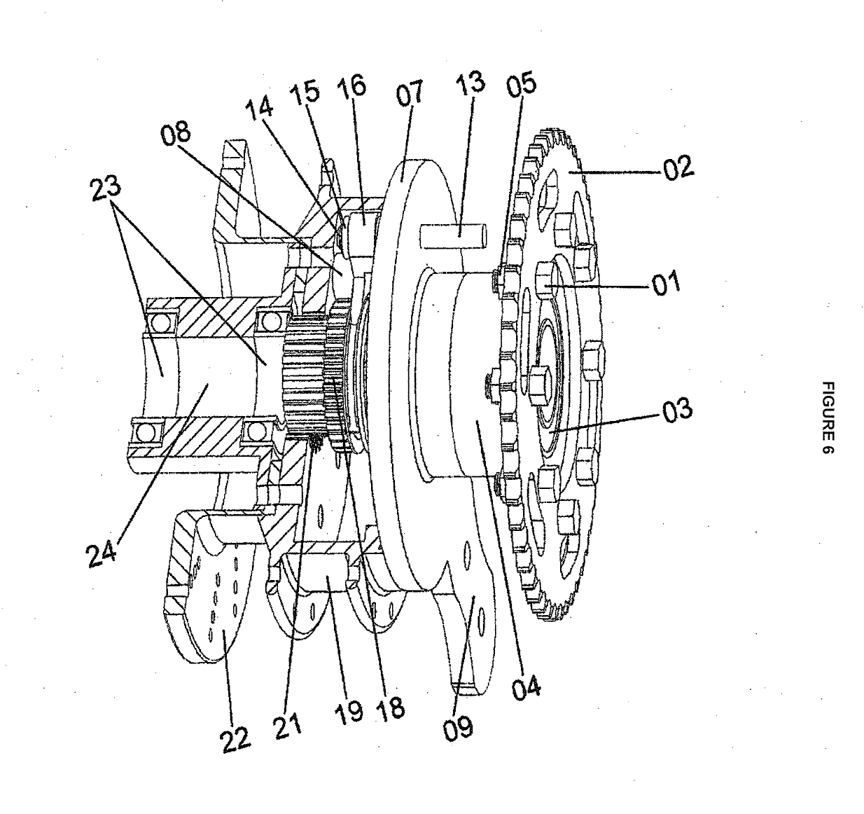

FIG. 7 is a perspective view of the a reversing apparatus with the reversing system disabled, i.e., with direct coupling moving “forward”, being partially assembled and with some parts cut, for a better view of the layout of the gearings.

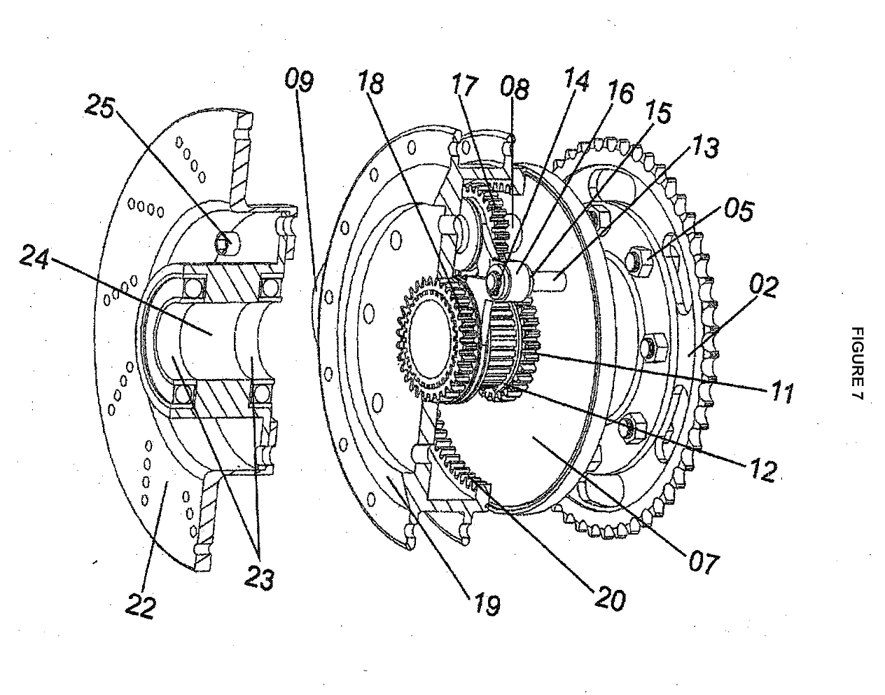

FIG. 8 is a perspective view of the a reversing apparatus of FIG. 7 with the reversing system disabled, fully assembled and maintaining the same parts cut for one to be able to view the layout of the gearings.

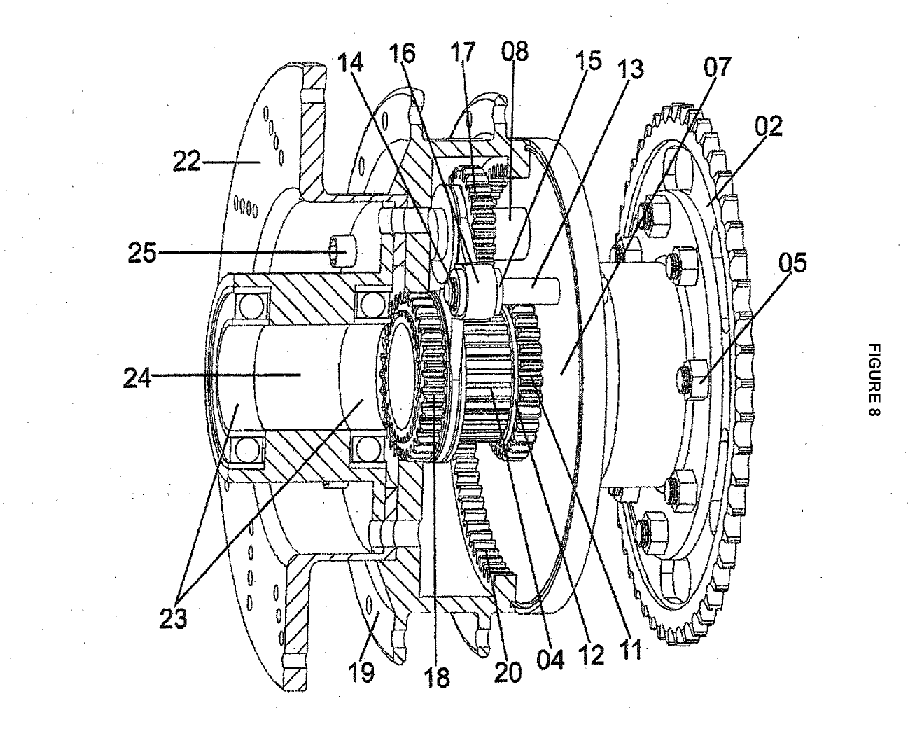

FIG. 9 is a perspective view of the a reversing apparatus disassembled, maintaining the same parts cut shown in FIGS. 03, 04, 05, 06, 07 and 08 for better comprehension.

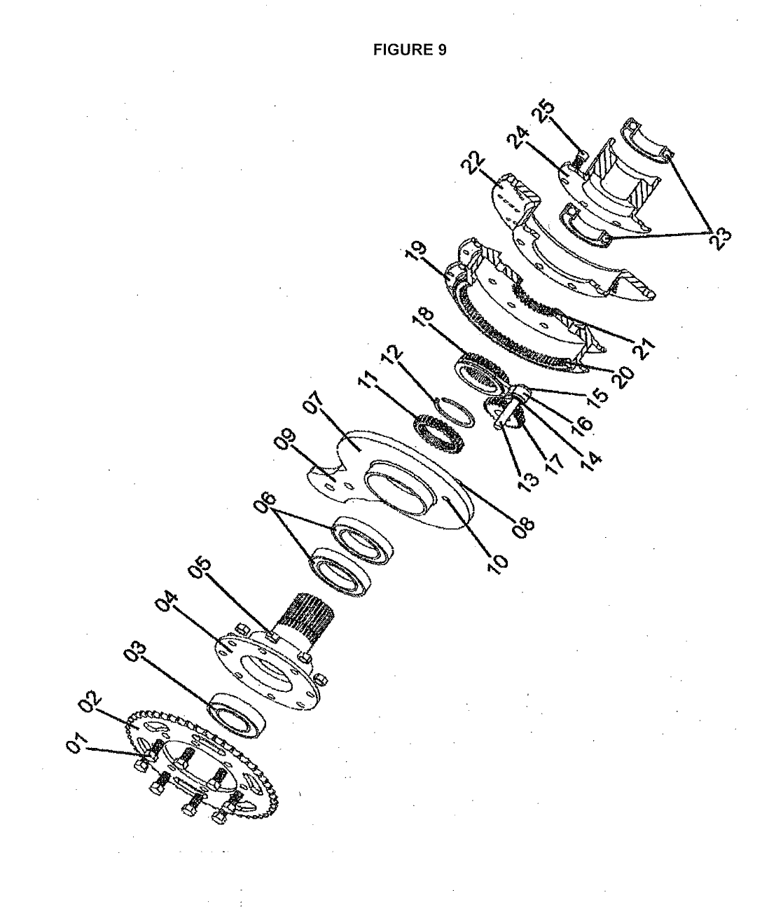

FIG. 10 is a perspective view of the reversing apparatus of FIG. 9, in a different angle.

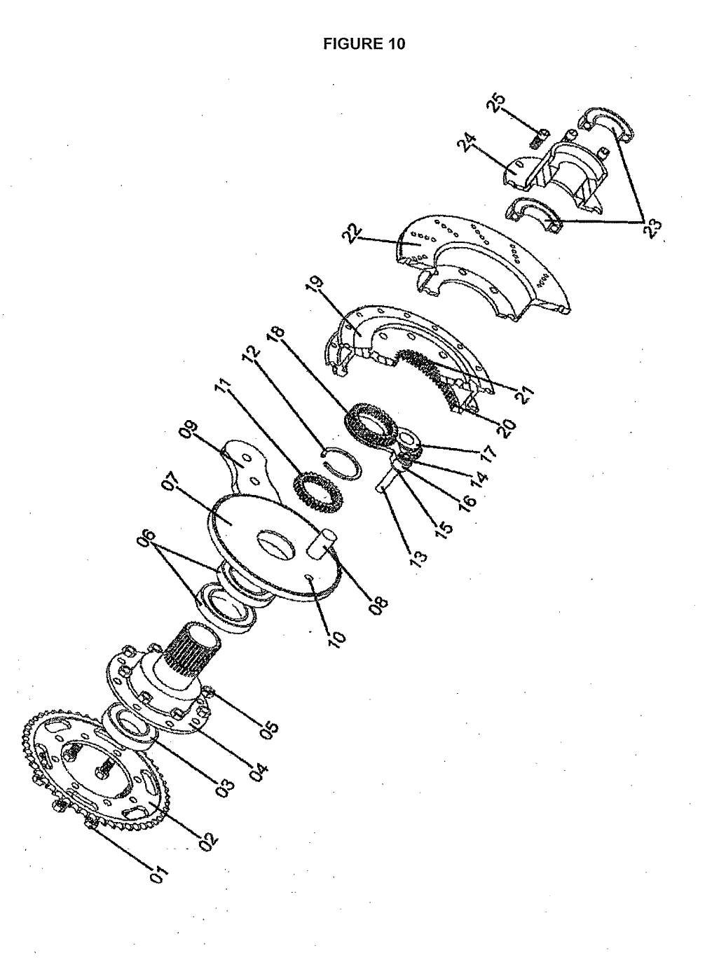

FIG. 11 is a perspective view of the reversing apparatus of FIG. 10, with the reversing gearing (17) and the direct coupling gearing (18) separated from the fork (16) for a supplementary view.

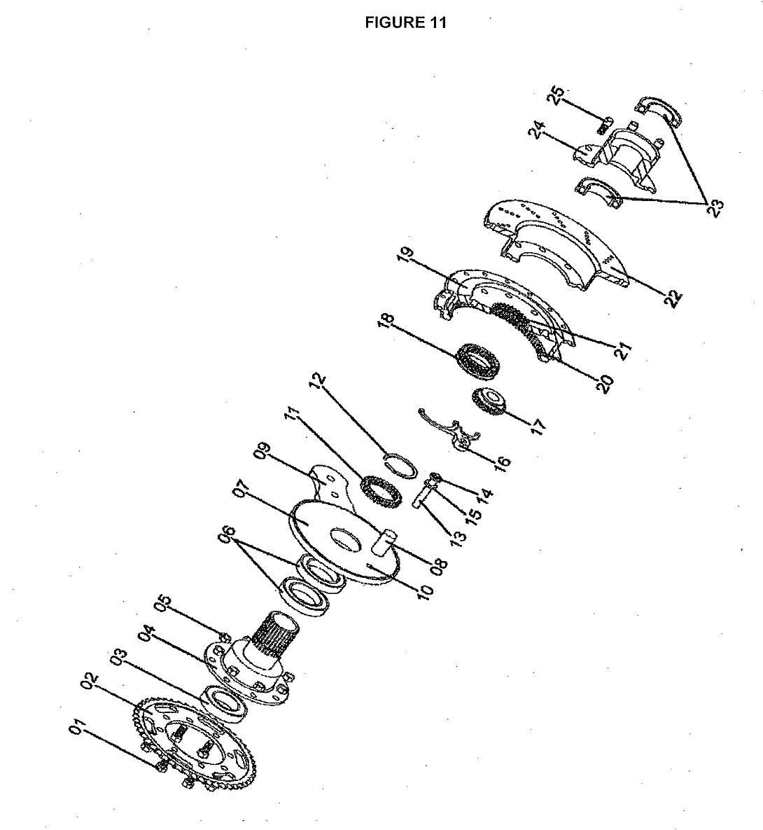

FIG. 12 is a perspective view of the reversing apparatus completely assembled.

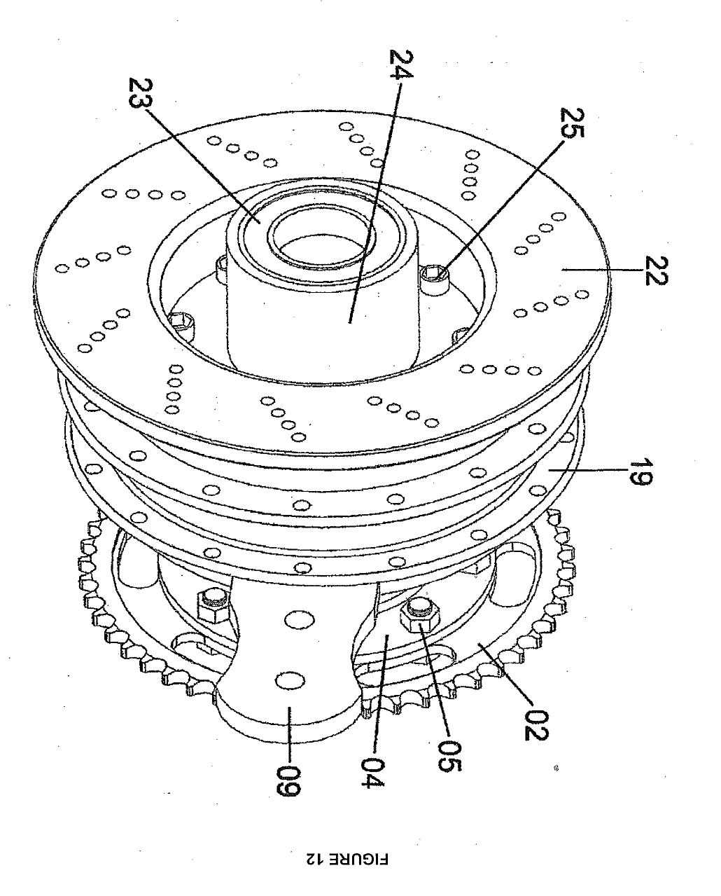

FIG. 13 is a perspective view of the reversing apparatus of FIG. 12, at a different angle.

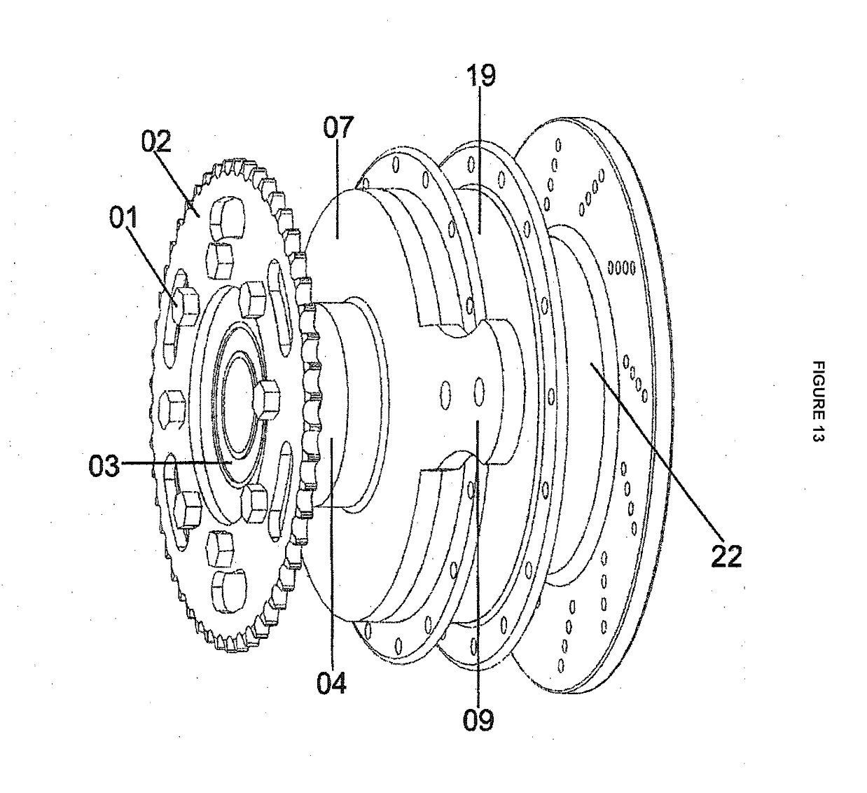

FIG. 14 is a perspective view of the reversing apparatus of FIG. 12 and FIG. 13, with a complete view of the outer part of the a reversing apparatus completely assembled.

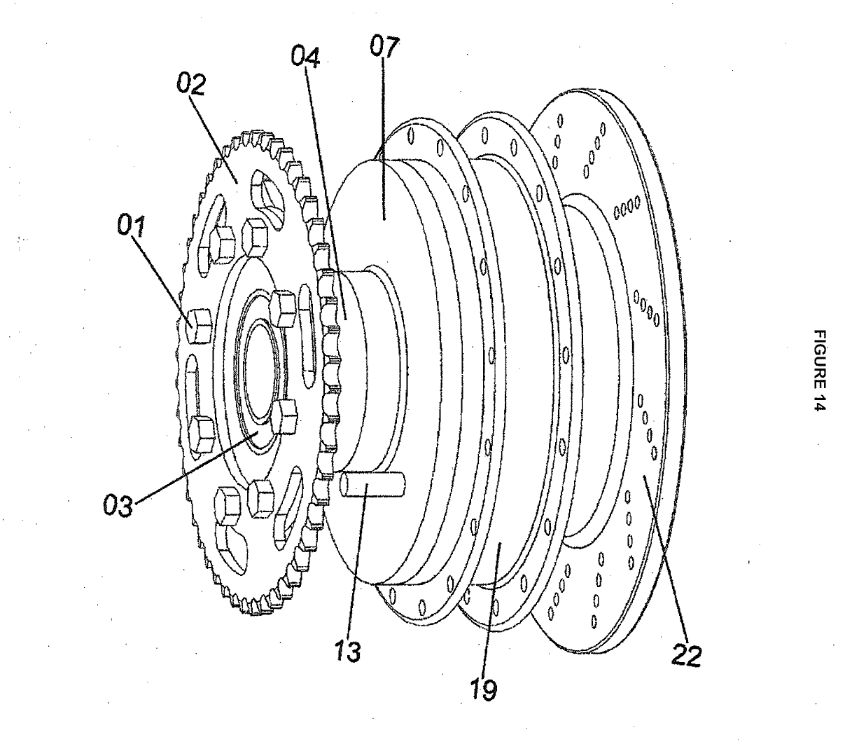

The REVERSING APPARATUS, aiming at replacing the traditional reversal systems that perform separately from the transmission box, is comprised by the CROWN FIXATION SCREWS (01), CROWN (02), FLANGE AXIS BEARING (03), by the FLANGED AXIS (04), by the CROWN FIXATION NUTS (05), by the PLATE BEARINGS (06), by the PLATE (07), by the REVERSING HUB GUIDE

AXIS (08), by the PLATE FIXATION ROD (09), by the FORK COUPLING AXIS GUIDE BORE (10) by the FLANGED AXIS FIXED GEAR (11), by the FLANGED AXIS FIXED GEAR LOCK ELASTIC RING (12), by the FORK COUPLING AXIS (13), by the FORK COUPLING AXIS ELASTIC RINGS (14), by the FORK REST WASHERS (15), by the FORK (16). By the REVERSING GEAR (17), by the

DIRECT COUPLING GEAR (18), by the REVERSING HUB (19), by the REVERSING HUB INNER-TEETHED GEARING (20), by the REVERSING HUB CUTTER (21) by the BRAKE DISK (22), by the SUPPORT HUB BEARINGS (23), by the SUPPORT HUB (24), and by the SUPPORT HUB SCREWS (25).

The CROWN FIXATION SCREWS (01) consist in eight metallic screws that, along with the CROWN FIXATION NUTS (05) which consist in eight metallic nuts, have the function of fixing the CROWN (02) to the FLANGED AXIS (04). The CROWN (02) consists in one straight-teeth metallic gear and has the function of transmitting force and motion resulting from the transmission box output of a motorcycle, tricycle, moped or any type of motor vehicle generating such force and motion. The FLANGED AXIS BERAING (03) consists in one metallic ball-bearing and has the function of coupling to the recess of the FLANGED AXIS (04) supporting a pin or an axis, such as, for instance, the pin of the rear scale of a motorcycle or to an axis of a tricycle, and, in any case, both a pin and an axis, shall trespass the REVERSING APPARATUS, enabling the REVERSING APPARATUS to rotate, except for the PLATE (07). The PLATE BEARINGS (06) consist in two metallic ball-bearings and have the function of coupling to the recess of the PLATE (07), fixing and enabling the FLANGED AXIS (04) to rotate. The FLANGED AXIS (04) consists in one metallic axis with cutters and one flange, and has the function of transmitting the motion/force applied on the CROWN (02) to the REVERSING HUB (19). The PLATE (07) consists in one metallic plate and has the function of supporting and enabling the FLANGED AXIS (04) to partially trespass the PLATE (07) until they rest on each other. The REVERSING GEAR GUIDE AXIS (08) consists in one fixed and immoveable metallic axis, and has the function of maintaining the REVERSING GEAR coupled (17), allowing it to rotate and move linearly. The PLATE FIXATION ROD (09) consists in one metallic rod forming one single piece along with the PLATE (07) and has the function of fixing the PLATE (07), for instance, to the rear scale of a motorcycle, the chassis of a tricycle or moped, or any type of motor vehicle that may use the REVERSING APPARATUS, maintaining it fixed and with no linear or rotation motion. The FORK COUPLING AXIS GUIDE BORE (10) consists in one bore located at the PLATE (07) and has the function of being a guide for the FORK COUPLING AXIS (13) providing the linear motion of the FORK COUPLING AXIS (13), which is triggered through the outer part of the PLATE (07). The FLANGED AXIS FIXED GEARING (11) consists in one straight-teethed metallic gearing and inner cutters, rotating along with the FLANGED AXIS (04) and having the function of forming the coupling between the REVERSING GEARING (17) and the REVERSING HUB INNER TEETH GEARING (20). The FLANGED AXIS FIXED GEARING LOCKING ELASTIC RING (12) consists in one metallic elastic ring and has the function of not allowing the FLANGED AXIS FIXED GEARING (11) to move linearly on the FLANGED AXIS (04). The FORK COUPLING AXIS (13) consists in one metallic axis and has the function of coupling and moving linearly the FORK (16). The FORK COUPLING ELASTIC RINGS (14) consist in two metallic elastic rings which, along with the FORK REST WASHERS (15), which consist in two smooth metallic washers, have the function of maintaining the FORK (16) fixed to the FORK COUPLING AXIS (13). The FORK (16) consists in one metallic fork similar to those used in transmission boxes, and has the function of coupling the REVERSING GEARING (17) and the DIRECT COUPLING GEARING (18), allowing the rotating motion thereof, at the same time as it moves them linearly and simultaneously for the coupling of one or another, i.e., upon positioning the REVERSING GEARING (17) between the FLANGED AXIS FIXED GEARING (11) and the a REVERSING HUB INNER-TEETHED GEARING (20), the REVERSING HUB (19) shall rotate in the opposite direction of the FLANGED AXIS (04). When the FORK (16) moves in the opposite direction, the REVERSING GEARING (17) is released at the same time that the DIRECT COUPLING GEARING (18) is coupled to the REVERSING HUB CUTTER (21), providing the direct coupling of the FLANGED AXIS (04) to the REVERSING HUB (19), causing both to rotate in the same direction. The REVERSING GEARING (17) consists in one straight-teethed metallic gearing with inner cutters and has the function of forming the coupling between the FLANGED AXIS FIXED GEARING (11) and the REVERSING HUB INNER-TEETHED GEARING (20). The DIRECT COUPLING GEARING (18) consists in one straight-teethed metallic gearing and has the function of coupling the DIRECT COUPLING GEARING (18) and the FLANGED AXIS (04) to the REVERSING HUB CUTTER (21). The REVERSING HUB (19) consists in one metallic hub and has the function of rotating in the same direction, or in the reverse direction, according to the coupling of the REVERSING GEARING (17) and of the DIRECT COUPLING GEARING (18). The REVERSING HUB INNER-TEETHED GEARING (20) consists in one straight-teethed metallic gearing and has the function of reversing the rotating direction between the FLANGED AXIS (04) and the REVERSING HUB (19) when the REVERSING GEARING (17) is coupled between the REVERSING HUB INNER-TEETHED GEARING (20) and the FLANGED AXIS FIXED GEARING (11). The REVERSING HUB CUTTER (21) consists in one cutter made in the center of the REVERSING HUB (19) and has the function of making the direct coupling between the FLANGED AXIS (04) and the REVERSING HUB (19), causing both to rotate in the same direction when the DIRECT COUPLING GEARING (18) is coupled to the REVERSING HUB CUTTER (21). The BRAKE DISK (22) consists in one cast iron disk and has the function of braking the REVERSING APPARATUS. The SUPPORT HUB BEARINGS (23) consists in two metallic ball-bearings and has the function of coupling to the SUPPORT HUB (24), providing sustentation and enabling the rotating motion of the REVERSING APPARATUS, for instance, around the passing pin of the rear scale of a motorcycle, the axis of a tricycle or moped, or any motor vehicle that may use the REVERSING APPARATUS. The SUPPORT HUB (24) consists in one metallic hub and has the function of providing support and sustentation to the SUPPORT HUB BEARINGS (23). The SUPPORT HUB SCREWS (25) consist in eight metallic screws and have the function of fixating the SUPPORT HUB (24) and the BRAKE DISK (22) to the REVERSING HUB (19).

The solution found for the problems existing in the reversing box systems performing separately from the transmission boxes currently existing may be clarified from the detailed description of the functioning of the reversing system that performs separately from the transmission box called “REVERSING HUB”, from which one must consider the principle that the PLATE (07), as well as the components that are part of the PLATE (07) form one single part, namely the REVERSING GEARING GUIDE AXIS (08), the PLATE FIXATION ROD (09), and the FORK COUPLING AXIS GUIDE BORE (10), form one component that may be fixed both to the rear scale of a motor vehicle such as a motorcycle, as to the chassis of a motor vehicle such as a tricycle or a moped, or to any motor vehicle that may receive such REVERSING APPARATUS, having no motion whatsoever, whether linear or rotating, i.e., being a fixed element, to which an analogy may be made of the PLATE (07) with the PLATE of the rear hub of a motorcycle that houses the brake shoes. The component to receive the force and the motion resulting from the generating mechanism, which, for instance, may be the transmission box output, shall be the CROWN (02), which is fixed to the FLANGED AXIS (04), and that the transmission results from a transmission chain. Fixed to the FLANGED AXIS (04) we have the FLANGED AXIS FIXED GEARING (11), which rotates along with the FLANGED AXIS (04), and has only rotation motion, since the FLANGED AXIS FIXED GEARING LOCK ELASTIC RING (12) maintains it fixed without linear motions (forward and backwards).

The PLATE (07) is trespassed by the FLANGED AXIS (04) until both meet their respective rests and the FLANGED AXIS FIXED GEARING (11) rests on the PLATE (07) wall. Then, we have the FORK COUPLING AXIS (13), which, through the FORK COUPLING ELASTIC RINGS (14) and FORK REST WASHERS (15), maintains the FORK (16) fixed to the FORK COUPLING AXIS (13), which, on its turn, slides linearly through the FORK COUPLING AXIS GUIDE BORE (10). Coupled to the FORK (16), we have the REVERSING GEARING (17) and the DIRECT COUPLING GEARING (18), having these two gearings rotation motion and are moved linearly (forward and backwards), through the FORK (16), which, on its turn, is moved by the FORK COUPLING AXIS (13). Coupled to the PLATE (07), we have the REVERSING HUB (19), which has an inner gearing called REVERSING HUB INNER-TEETHED GEARING (20) and the REVERSING HUB CUTTER (21). The BRAKE DISK (22) and the SUPPORT HUB (24) are coupled to the REVERSING HUB (19) and fixated by the SUPPORT HUB SCREWS (25). The REVERSING APPARATUS has bearings, and the FLANGED AXIS BEARING (03), and the OS SUPPORT HUB BEARINGS (23) serve to fixate the REVERSING APPARATUS to the passing pin of the rear scale of a motor vehicle such as a motorcycle, or to the axis of a motor vehicle such as a tricycle or a moped, or to any other motor vehicle that may use the REVERSING APPARATUS, causing the REVERSING APPARATUS to rotate, except for the PLATE (07). The PLATE BEARINGS (06) serve to fixate the FLANGED AXIS (04) enabling its rotation. The REVERSING HUB (19) has the external function of serving as the rear wheel hub for a motor vehicle such as a motorcycle, which may be a hub with volts fixed to that rear wheel hub, and to the rim of the wheel of a motor vehicle such as a motorcycle, or to any other motor vehicle that may use the REVERSING APPARATUS such as to the hub of a light alloy wheel. The REVERSING HUB (19) may also be coupled to a satellite box of motor vehicles such as tricycles and mopeds, or to any other motor vehicle that may use the REVERSING APPARATUS. The REVERSING HUB (19), due to its constructive and functional characteristics of providing final transmission in a motor vehicle, may be coupled to a large array of components according to the need presented. The great advantage of the REVERSING APPARATUS compared to the traditional reversing boxes currently used in motor vehicles lies in its constructive and functional system, as well as in how the coupling of gearings occurs for the occurrence of reversing or direct enabling, and, in order for reversal to occur in the wheel motion direction, i.e., for reverse gear, the FORK COUPLING AXIS (13) must be enabled linearly in the direction of the CROWN (02), causing the FORK (16) coupled to the FORK COUPLING AXIS (13) to position the REVERSING GEARING (17) between the REVERSING HUB INNER-TEETHED GEARING (20) and the FLANGED AXIS

FIXED GEARING (11), causing the REVERSING HUB (19) to rotate in the opposite direction of the FLANGED AXIS (04) and the CROWN (02), at the same time the DIRECT COUPLING GEARING (18) remains rotating freely along with the FLANGED AXIS (04), without any coupling relative to the REVERSING HUB (19). In order for reverse gear to be disabled and the wheel motion direction to be forward, the FORK COUPLING AXIS (13) must be moved into the opposite direction as it was before, when the reverse gear was enabled, wherein the FORK (16) shall cause the REVERSING GEARING (17) to be de-coupled of the REVERSING HUB INNER-TEETHED GEARING (20) and of the FLANGED AXIS FIXED GEARING (11), moving linearly through the REVERSING GEARING GUIDE AXIS (06), at the same time the DIRECT COUPLING GEARING (18), which is also enabled by the FORK (16), fits on the REVERSING HUB CUTTER (21), causing the REVERSING HUB (19) to rotate in the same direction as the FLANGED AXIS (04) and the CROWN (02), in the same moment as the REVERSING GEARING (17) remains with no rotation motion and totally de-coupled, and the REVERSING HUB INNER-TEETHED GEARING (20) and the FLANGED AXIS FIXED GEARING (11) remain rotating freely. Thus, one obtains a REVERSING HUB APPARATUS designed and built with the purpose of providing an improvement in the reversing systems performing separately from the sequential gearbox of motor vehicles such as tricycles, mopeds and motorcycles, as well as other land and aquatic motor vehicles, being installed separately from the original gearbox of such motor vehicles without changing the composition and functioning of the gearbox, so as to provide that the driver has not only a reverse gear, but is also able to reduce/increase gears sequentially, moving the vehicle both forward and backwards.

1-16. (canceled)

17. A reversing apparatus for reversing a vehicle, the vehicle having an engine, a driveline means coupled to the engine, and a driving means; the reversing apparatus comprising:
a) a crown constructed and arranged to receive the driveline means;
b) an axis coupled to the crown;
c) a hub coupled to the driving means, the hub comprising a direct drive gear and a reverse drive gear, and
d) an actuator coupling the axis to either the direct drive gear or to the reverse drive gear,
wherein when the axis is coupled to the direct drive gear the hub rotates in the same direction as the axis and wherein when the axis is coupled to the reverse drive gear the hub rotates in the opposite direction as the axis.

18. The reversing apparatus of claim 17 wherein the driveline means includes a sequential gearbox having sequential gears and the reversing apparatus is located after the sequential gearbox allowing the sequential gears to be used when reversing the vehicle and when the vehicle is going forward.

19. The reversing apparatus of claim 17 wherein the reversing apparatus is connected to a rear wheel hub of a motorcycle.

20. The reversing apparatus of claim 17 wherein the reversing apparatus is installed on a prime transmission axis of a vehicle selected from the group consisting of: a moped, a tricycle, an automobile, and an aquatic vehicle.

21. The reversing apparatus of claim 17, wherein the actuator comprises:
a direct coupling gear coupled to the axis; and
a fork adjacent to the axis that is movable from a direct drive position to a reverse drive position,
wherein the fork is coupled to the direct coupling gear in a manner allowing the direct coupling gear to move linearly along the axis from the direct drive position to the reverse drive position,
wherein when the direct coupling gear is in the direct drive position the direct coupling gear couples to the direct drive of the hub to rotate the hub in the same direction of the axis, and
wherein when the direct coupling gear is in the reverse drive position the direct coupling gear is not coupled to the direct drive of the hub.

22. The reversing apparatus of claim 21 wherein the actuator further comprises a reversing gear adjacent to the axis coupled to the fork in a matter allowing the reversing gear to move linearly relative to the axis from the direct drive position to the reverse drive position,
wherein when the reversing gear is in the direct drive position it is not coupled to the reverse drive gear of the hub,
wherein when the reversing gear is in the reverse drive position it is coupled to the axis and to the reverse drive gear of the hub to rotate the hub in the opposite direction of the axis; and
wherein the fork is coupled to both the reversing gear and the direct drive gear in a manner allowing the fork to move both the reversing gear and the direct drive gear simultaneously.

23. The reversing apparatus of claim 17 wherein the actuator is actuated by the driver.

24. The reversing apparatus of claim 22 wherein the reversing apparatus further comprises:
a fixed gear ring that is coupled to the axis, and
a fixed gearing lock ring that is coupled to the axis and prevents the axis fixed gear ring from moving linearly along the axis,
wherein, the fixed gear ring is coupled to the axis in a manner that allows the fixed gear ring to rotate in the same direction as the axis, and
wherein the fixed gear couples the reversing gear to the axis when the reversing gear is in the reverse drive position.

25. The reversing apparatus of claim 24 wherein the reversing apparatus further comprises:
a plate adjacent to the hub, the plate having an opening and a fixation rod; and
at least one plate-bearing received by the opening of the plate,
wherein the fixation rod secures the plate to the vehicle in a manner that prevents both rotation and linear movement of the plate,
wherein the at least one plate-bearing is trespassed by the axis allowing the axis to rotate within the plate, and
wherein the fixed axis gear rests against the plate.

26. The reversing apparatus of claim 25, wherein the actuator further comprises a fork-coupling axis, and
wherein the plate further comprises a fork-coupling bore,
wherein the fork-coupling bore receives the fork-coupling axis allowing the fork to move linearly relative to the plate, and
wherein the fork is prevented from rotating relative to the axis.

27. The reversing apparatus of claim 26 further comprising:
an axis bearing coupled to the axis;
a brake disk coupled to the hub;
a support hub coupled to the brake disk having an opening
at least two support hub bearings received by the opening of the support hub,
wherein the flanged axis bearing and support hub bearings fixate the reversing apparatus to a pin on the vehicle.
